(19) United States
(12) Patent Application Publication
(10) Pub. No.: US 2020/0362154 A1
(43) Pub. Date: Nov. 19, 2020

(54) HIGH RESILIENCY FOAMS AND COMPONENTS AND ARTICLES FORMED THEREFROM

(71) Applicant: NIKE, Inc., Beaverton, OR (US)

(72) Inventor: HyungUk Park, Beaverton, OR (US)

(21) Appl. No.: 16/966,735

(22) PCT Filed: Jan. 31, 2019
(86) PCT No.: PCT/US2019/016084

§ 371 Date: Jul. 31, 2020

Related U.S. Application Data
(60) Provisional application No. 62/624,292, filed on Jan. 31, 2018.

(51) Int. Cl. C08L 33/06

(52) U.S. Cl. CPC C08L 33/06; C08L 2205/03; C08L 2205/025

(57) ABSTRACT

High resiliency foams are provided as well as articles and components formed therefrom. In various aspects, resin compositions are provided including a compatibilized polymer blend of a first ethylene vinyl acetate copolymer and an olefinic thermoplastic elastomer. In some aspects, the resin compositions can include about 65 parts per hundred resin to about 100 parts per hundred resin of the compatibilized polymer blend, about 0 to about 20 parts per hundred resin of a second ethylene vinyl acetate copolymer; about 0.1 parts per hundred resin to about 5 parts per hundred resin of zinc oxide; about 1 parts per hundred resin to about 10 parts per hundred resin of calcium carbonate; about 1 parts per hundred resin to about 10 parts per hundred resin of a chemical blowing agent; and about 0.1 parts per hundred resin to about 1.5 parts per hundred resin of a crosslinking agent.

### CROSS-REFERENCE TO RELATED APPLICATIONS

This application claims priority to, and the benefit of, co-pending U.S. provisional application entitled “HIGH RESILIENCY FOAMS AND COMPONENTS AND ARTICLES FORMED THEREFROM” having Ser. No. 62/624,292, filed Jan. 31, 2018, the contents of which are incorporated by reference in their entirety.

### TECHNICAL FIELD

The present disclosure generally relates to materials, and in particular to materials for the footwear, apparel, and sporting equipment, and related industries and uses thereof.

### BACKGROUND

Footwear design involves a variety of factors from the aesthetic aspects, to the comfort and feel, to the performance and durability. While footwear design and fashion may be rapidly changing, the demand for increasing performance in the athletic footwear market is unchanging. To balance these demands, footwear designers employ a variety of materials and designs for the various components that make up an article of footwear.

### BRIEF DESCRIPTION OF THE DRAWINGS

Further aspects of the present disclosure will be readily appreciated upon review of the detailed description, described below, when taken in conjunction with the accompanying drawings.

FIG. 1 is an elevation view of an exemplary article of footwear with a sole component according to an aspect of the invention.

FIG. 2 is an exploded view of the sole component of the exemplary article of footwear of FIG. 1.

FIG. 3 is a plan view of the bottom of the sole component of the exemplary article of footwear of FIG. 1.

FIG. 4 is a bottom view of an exemplary insert for use in a sole component of an article of footwear according to an aspect of the invention.

FIG. 5 is a top view of the exemplary insert of FIG. 4 inserted in a first portion to form a second exemplary sole component according to an aspect of the invention.

FIG. 6 is a front view of exemplary shoulder pads.

### DETAILED DESCRIPTION

New designs and materials for the footwear industry are needed. In particular, there remains a need for improved foam compositions, for example that can be used in the footwear industry to provide improved cushion and high resiliency when used in a sole or other component for an article of footwear.

Applicants have discovered that the use of resin compositions including compatibilized blends of olefinic thermoplastic elastomers (TPE) and ethylene vinyl acetate (EVA) copolymers can be used to produce foams which have excellent mechanical properties while being easy to process. The resin compositions of the disclosure include about 65 parts per hundred resin to about 100 parts per hundred resin of a polymer blend, the polymer blend comprising a first ethylene vinyl acetate copolymer and a olefinic thermoplastic elastomer, wherein the polymer blend is a compatibilized blend. The resin compositions also include from 0 to about 20 parts per hundred resin of a second ethylene vinyl acetate copolymer; about 0.1 parts per hundred resin to about 5 parts per hundred resin of zinc oxide; about 1 parts per hundred resin to about 10 parts per hundred resin of calcium carbonate; about 1 parts per hundred resin to about 10 parts per hundred resin of a chemical blowing agent; and about 0.1 parts per hundred resin to about 1.5 parts per hundred resin of a crosslinking agent. Optionally, the resin compositions include a dye or pigment. In particular examples, the compatibilized blend of the resin has a melt flow index of about 0.7 grams per 10 minutes to about 1.0 grams per 10 minutes. The foam compositions of the disclosure are crosslinked and foamed reaction products of the resin compositions of the disclosure. In particular examples, the foam compositions have an energy return of about 70% to about 85%, or have a split tear of about 1.6 kg/cm to about 4.0 kg/cm, or have an Asker C hardness of about 40 to 60 C, or a compression set of about 30% to about 75%, or any combination thereof.

In various aspects, this disclosure provided compositions that can be foamed, i.e. can be used to produce a foam composition. For clarity, compositions that have not been foamed will, in some instances be referred to as “pre-foam” compositions. This disclosure also provides foam compositions, e.g. compositions that have been prepared by foaming a “pre-foam” composition described herein. In various aspects, this disclosure described articles of footwear, such as athletic shoes, and components thereof including one or more of the foam compositions. In particular, various aspects of the present disclosure describe sole components for an article of footwear having exceptionally high resiliency. The sole components having exceptionally high resiliency can be made from foaming a pre-foam composition described herein. In some aspects, this disclosure also provides foam components for apparel or sporting equipment, as well as apparel and sporting equipment containing the foam components described herein. Methods of making the compositions and components made therefrom are also provided.

Before the present disclosure is described in greater detail, it is to be understood that this disclosure is not limited to particular aspects described, and as such may, of course, vary. Other systems, methods, features, and advantages of foam compositions and components thereof will be or become apparent to one with skill in the art upon examination of the following drawings and detailed description. It is intended that all such additional systems, methods, features, and advantages be included within this description, be within the scope of the present disclosure, and be protected by the accompanying claims. It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Articles of Footwear, Apparel, or Sporting Equipment

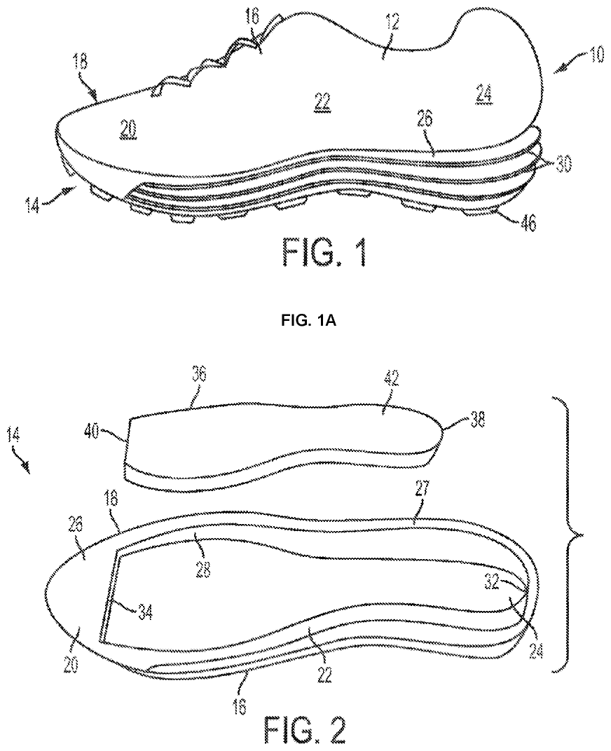

In various aspects, this disclosure is directed to articles of footwear. In particular, aspects of the disclosure include articles of footwear including one or more components made entirely or partially from a foam mentioned above and described in more detail below. The foams and components made therefrom can have a range of desirable properties for footwear, including softness, durability, and an exceptionally high resiliency. The articles of footwear can, in principal, include any article of footwear. An exemplary article of footwear 10 is shown in FIG. 1. While an athletic shoe is exemplified in FIG. 1, it will be readily understood that some of the terminology employed will also apply to other articles of footwear. Footwear 10 includes an upper 12 and a sole component 14 secured to upper 12. Sole component 14 can be be secured to upper 12 by adhesive or any other suitable means. As used herein, the sole component 14 can be a monolithic component formed entirely of the foam material as described herein, or a multi-component assembly formed of a plurality of monolithic components, where at least one of the monolithic components is formed entirely of the foam material as described herein. Footwear 10 has a medial, or inner, side 16 and a lateral, or outer, side 18.

The upper, in some aspects, is unformed until the point that it is attached to the sole component. In some aspects, the upper is a lasted upper. A “lasted upper,” as used herein, refers to an upper that is formed into the shoe shape prior to attachment to the sole by one or more mechanical means. The lasted upper can include a heel counter formed to shape the heel of the upper. The lasted upper can include a strobel sock or a strobel board attached to the upper, typically via a strobel stitch.

Sole component 14, which is generally disposed between the foot of the wearer and the ground, provides attenuation of ground reaction forces (i.e., imparting cushioning), traction, and may control foot motions, such as pronation. As with conventional articles of footwear, sole component 14 can include an insole (not shown) located within upper 12. In some aspects, the sole component is an insole or sockliner or is a multi-component assembly including an insole or sockliner, can further include an insole or sockliner located within the upper, where the insole or sockliner is formed entirely or partially of a foam material described herein. In various aspects, articles of footwear described herein include an insole or sockliner formed entirely or partially of a foam material described herein.

The most common components of shoes and other footwear can be classified into one of three types of components: upper components, lower components, and grindery components. Upper components refer collectively to all of the components that are stitched or otherwise joined together to form the upper. The materials in the upper generally contribute to characteristics such as breathability, conformability, weight, and suppleness or softness. The lower components refer collectively to all of the components that collectively form the lower. The lower can include, for example, the outsole and midsole. The choice of outsole materials and design will contribute, for instance, to the durability, traction, as well as to the pressure distribution during use. The midsole materials and design contribute to factors such as the cushioning and support. Grindery components include all of the additional components that can be attached to the upper, lower, or both. Grindery components can include, for example, eyelets, toe puffs, shanks, nails, laces, velcro, catches, backers, linings, padding, heel backings, heel foxings, toe caps, etc.

For purposes of general reference, footwear 10 can be divided into three general portions: a forefoot portion 20, a midfoot portion 22, and a heel portion 24. Portions 20, 22, and 24 are not intended to demarcate precise areas of footwear 10. Rather, portions 20, 22, and 24 are intended to represent general areas of footwear 10 that provide a frame of reference during the following discussion.

Unless otherwise stated, or otherwise clear from the context below, directional terms used herein, such as rearwardly, forwardly, top, bottom, inwardly, downwardly, upwardly, etc., refer to directions relative to footwear 10 itself. Footwear is shown in FIG. 1 to be disposed substantially horizontally, as it would be positioned on a horizontal surface when worn by a wearer. However, it is to be appreciated that footwear 10 need not be limited to such an orientation. Thus, in FIG. 1, rearwardly is toward heel portion 24, that is, to the right as seen in FIG. 1. Naturally, forwardly is toward forefoot portion 20, that is, to the left as seen in FIG. 1, and downwardly is toward the bottom of the page as seen in FIG. 1. Top refers to elements toward the top of the page as seen in FIG. 1, while bottom refers to elements toward the bottom of the page as seen in FIG. 1. Inwardly is toward the center of footwear 10, and outwardly is toward the outer peripheral edge of footwear 10.

Unless otherwise stated, or otherwise clear from the context below, directional terms used herein, such as rearwardly, forwardly, top, bottom, inwardly, downwardly, upwardly, etc., refer to directions relative to footwear 10 itself. Footwear is shown in FIG. 1 to be disposed substantially horizontally, as it would be positioned on a horizontal surface when worn by a wearer. However, it is to be appreciated that footwear 10 need not be limited to such an orientation. Thus, in FIG. 1, rearwardly is toward heel portion 24, that is, to the right as seen in FIG. 1. Naturally, forwardly is toward forefoot portion 20, that is, to the left as seen in FIG. 1, and downwardly is toward the bottom of the page as seen in FIG. 1. Top refers to elements toward the top of the page as seen in FIG. 1, while bottom refers to elements toward the bottom of the page as seen in FIG. 1. Inwardly is toward the center of footwear 10, and outwardly is toward the outer peripheral edge of footwear 10.

As can be seen in FIG. 2, sole component 14 has a first portion 26 having an upper surface 27 with a recess 28 formed therein. Upper surface 27 is secured to upper 12 with adhesive or other suitable fastening means. A plurality of substantially horizontal ribs 30 is formed on the exterior of first portion 26. In certain aspects, ribs 30 extend from a central portion of forefoot portion 20 on medial side 16 rearwardly along first portion 26, around heel portion 24 and forwardly on lateral side 18 of first portion 26 to a central portion of forefoot portion 20.

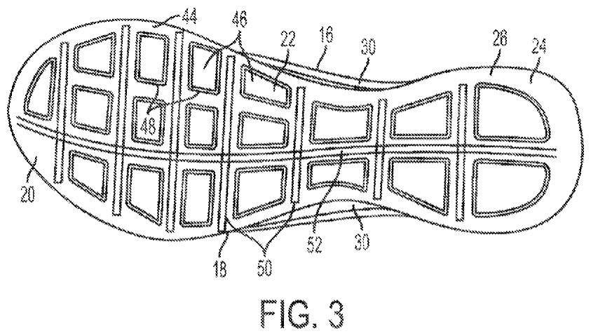

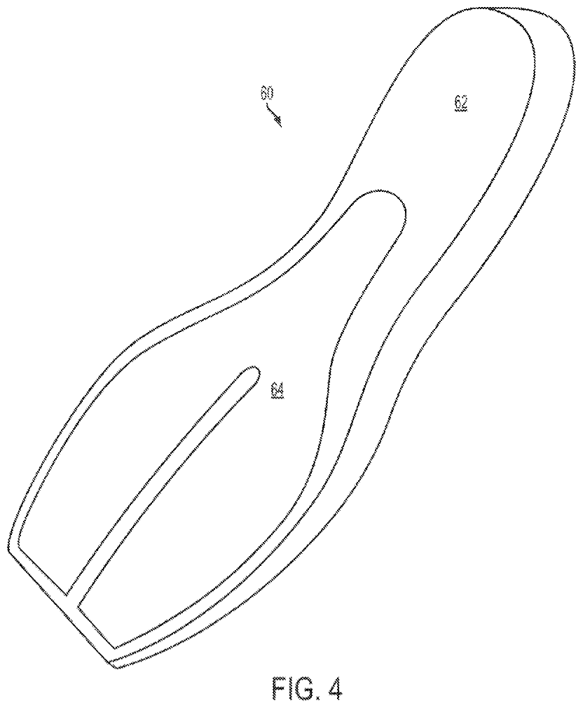

First portion 26 provides the external traction surface of sole component 14. In certain aspects it is to be appreciated that a separate outsole component can be secured to the lower surface of first portion 26. Recess 28 extends from heel portion 24 to forefoot portion 20. In certain aspects, the rear surface 32 of recess 28 is curved to substantially follow the contour of the rear of heel portion 24 and the front surface 34 of recess 28 extends transversely across first portion 26. An insert 36 is received in recess 28. Insert 36 has a curved rear surface 38 to mate with curved rear surface 32 of recess 28 and a transverse front surface 40 to mate with transverse front surface 34 of recess 28. An upper surface 42 of insert 36 is in contact with and secured to upper 12 with adhesive or other suitable fastening means. As seen best in FIG. 3, a ground engaging lower surface 44 of first portion 26 includes a plurality of projections 46. Each projection 46 is surrounded by a groove 48. A plurality of transverse slots 50 are formed in lower surface 44, extending between adjacent projections 46. A longitudinal slot 52 extends along lower surface 44 from heel portion 26 to forefoot portion 20. As illustrated in FIG. 2, insert 36 can provide cushioning or resiliency in the sole component. First portion 26 can provide structure and support for insert 36. In such aspects, first portion 26 can be formed of a material of higher density and/or hardness as compared to insert 36 such as, for example, non-foam materials including rubber and thermoplastic polyurethane, as well as foam materials. In certain aspects, insert 36 can be formed of a foam material as disclosed herein.

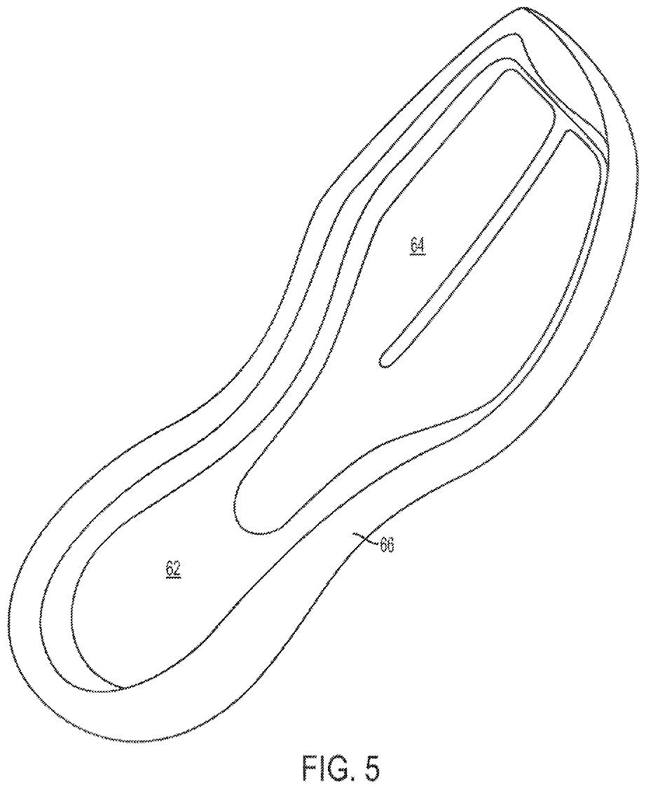

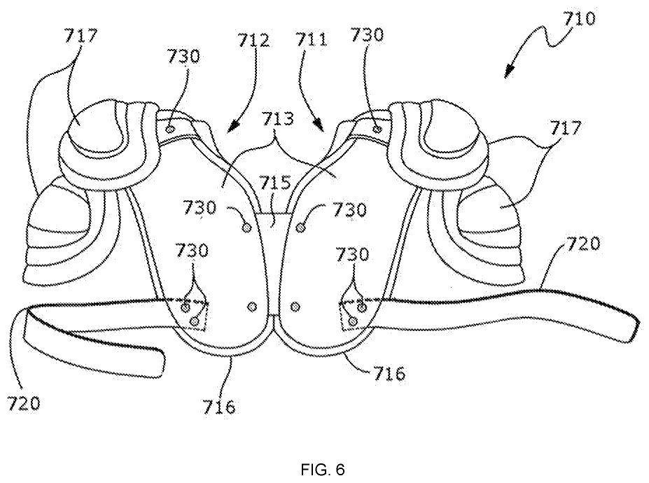

FIGS. 4 and 5 show bottom and top views of an exemplary insert 60 which can be used in a sole component as described herein. Insert 60 is similar to insert 36, but as illustrated in FIGS. 4 and 5, insert 60 is formed of two types of materials 62 and 64, where at least one of the materials is a foam as disclosed herein. FIG. 4 shows a bottom view of insert 60, while FIG. 5 shows a top view of insert 60 formed of two types of materials 62 and 64, with the insert placed inside a first portion 66 to form a sole component 14. Inserts with more than two types of materials, at least one of which is a foam as disclosed herein, can also be used. In the example illustrated in FIGS. 4 and 5, a portion of a first material 62 can be used in the heel region of the insert, and a portion of a second material 64 can be used in the toe region of the insert. A higher density material can be used to support the heel region, while a lower density material can be used to support the toe region. For example, the density of the first material can be at least 0.02 g/cm³ greater than the density of the second material. The shape of the portions of the two materials 62 and 64 of the insert can be any suitable shape. For example, the heel region can be in the shape of a wedge. Inserts formed of two types of materials can be useful in running shoes, as well as in basketball shoes.

While the compositions and foams described herein can be used for making any of a variety of components for an article of footwear, in particular aspects the components include a sole, a midsole, an outsole, an insole, a tongue padding, a collar padding, and a combination thereof. In some aspects, the component is a sole component, such as a sole component 14 depicted in FIGS. 1-5, that includes a foam described herein. In some aspects, the component is an insert such as insert 36 or insert 60 depicted in FIGS. 4-5 that includes a foam described herein. The sole components and inserts for sole components can be made partially or entirely of a foam described herein. Any portion of a sole component or an insert for a sole component can be made of a foam described herein. For example, first portion 26 of the sole component (optionally including the ground engaging lower surface 44, such as the plurality of projections 46 and/or the groove 48 surrounding the projections), the entire insert 36, portions 62 or 64 of insert 60, a separate outsole component, or any combination thereof, can include a foam as described herein. The sole components and inserts can be made by foaming a composition provided herein, for example by injection molding or by injection molding followed by compression molding as described herein. The foams and components can demonstrate improved physical properties including one or more of an enhanced resiliency, an enhanced split tear, a decreased specific density, or a combination thereof.

In addition to articles of footwear and components for articles of footwear, many articles of apparel and sporting equipment and components therefore have similar requirements of an enhanced resiliency, an enhanced split tear, a decreased specific density, or a combination thereof. For example, in some aspects the article is a component for an article of sporting equipment. The component can include a cushioning component formed from a foamed composition described herein. Cushioning components are used, for instance in protective gear, such as a shoulder pad, a hip pad, a shin pad, an elbow pad, a thigh pad, a knee pad, a helmet, a visor, a glove, or a combination thereof.

The article of sporting equipment can be shoulder pads. Shoulder pads can be used in a variety of sports, for example in football or lacrosse, or as protective gear in mountain biking or the like. An exemplary shoulder pads 710 is depicted in FIG. 6. Shoulder pads 710 include a variety of laterally connected right and left protective plate members 711/712, each protective plate member 711/712 has a front protective plate 713 and a back protective plate (not pictured), and a cushioning system having a plurality of padded bodies or members 716, the cushioning system being positioned internally to the plastic protective plate members 711/712. The protective plate members 711/712 are relatively thin in cross-section as compared to their maximum length and width, and can be formed from a resin composition described herein. The protective plate members 711/712 are each formed as a unitary, generally U-shaped member that extends across one shoulder of the wearer. The front protective plates 713 are connected to each other by flexible lateral joining members 715. Shoulder protective plates 717 are secured to the upper bridging portion of each protective plate members 711/712. The lower portion of each font protective plate 713 is joined to the lower portion of its corresponding rear protective plate by an adjustable underarm strap 720. The shoulder pads 710 can be assembled using a variety of techniques. For example, in some aspects, the protective plates, pads, and straps can be attached using low profile fasteners 730 such as rivets. In some aspects, the protective plates, pads, and straps are attached using an adhesive or using a mechanical bonding.

The foam components provided herein exhibit a variety of properties including an enhanced resiliency, an enhanced split tear, a decreased specific density, or a combination thereof.

Split tear is an important physical property for a foam for a component of an article of footwear or athletic equipment. In some aspects, the foam or component can have a split tear value of about 1.0 kg/cm to 4.5 kg/cm, about 1.6 kg/cm to 4.0 kg/cm, about 2.0 kg/cm to 4.0 kg/cm, about 2.0 kg/cm to 3.5 kg/cm, or about 2.5 kg/cm to 3.5 kg/cm. The split tear can be measured according to the Split Tear Test Method described below.

The resiliency (or energy return), a measure of the percentage of energy the foam or component returns when compressed, is an important physical property. This is especially true for running and other athletic shoes. In some aspects, the foams and components provided herein have an energy return of about 60% to 90%, about 60% to 85%, about 65% to 85%, or about 70% to 85%. The energy return can be measured according to the Energy Return Test Methods described below.

In some aspects, the foams and components provided herein have an Asker C hardness of about 30 to 65 C, about 40 to 65 C, or about 40 to 60 C. The Asker C Hardness can be measured according to the Durometer Hardness Test as described below.

The foams and components can be lightweight. In some aspects, the foams and components can have a specific density of about 0.05 to 0.25, about 0.05 to 0.2, about 0.05 to 0.15, about 0.08 to 0.15, about 0.08 to 0.20, about 0.08 to 0.25, or about 0.1 to 0.15. In some aspects the foam or component is compression molded and can have a specific density of about 0.15 to 0.3, about 0.2 to 0.3, or about 0.15 to 0.25.

The specific gravity of a foam is also an important physical property to consider when using a foam for a component of an article of footwear or athletic equipment. The foams and components of the present disclosure can have a specific gravity of from 0.02 g/cm³ to 0.22 g/cm³, or of from 0.03 g/cm³ to 0.12 g/cm³, or of from 0.04 g/cm³ to 0.10 g/cm³, or from 0.11 g/cm³ to 0.12 g/cm³, or from 0.10 g/cm³ to 0.12 g/cm³, from 0.15 g/cm³ to 0.2 g/cm³; 0.15 g/cm³ to 0.30 g/cm³.

Compression set of a foam is another important physical property for a foam used as a component of an article of footwear or athletic equipment. In accordance with the present disclosure, the compression molded foam or compression molded component can have a compression set of from 40% to 100%. For example, the compression set can be from 45% to 90%, from 40% to 80%, from 50% to 75%, or from 30% to 75%. The compression set can be measured according to the Compression Set Test described below.

Resin Compositions

In various aspects, this disclosure is directed to resin compositions. In particular, this disclosure describes several aspects of a resin composition that can be foamed to generate a higher-resiliency foam component.

Applicants have discovered that compatibilized blends of olefinic thermoplastic elastomers (TPE) and ethylene vinyl acetate (EVA) copolymers can be used to produce foams which have excellent mechanical properties while being easy to process. The polymer blend includes a first ethylene vinyl acetate copolymer and an olefinic thermoplastic elastomer, wherein the polymer blend is a compatibilized blend. The polymer blend will therefore sometimes be referred to as the “compatibilized polymer blend” or the “compatibilized blend”. Such compatibilized blends can be used to form resin compositions that, when foamed, have high resiliency, an enhanced split tear, a decreased specific density, or a combination thereof. The compatibilized blends can exhibit domain sizes of the EVA-rich regions, the TPE-rich regions, or both, in the resin blend, that are reduced in volume. For example, the domains may be at least 10% smaller in volume as compared to a similar blends that have not been compatibilzed. In some aspects, the olefinic thermoplastic elastomer includes a polyether-polyester thermoplastic elastomer. In various aspects, the compatibilized blend has a melt flow index of about 0.7 grams per 10 minutes to about 1.0 grams per 10 minutes, or about 0.75 grams per 10 minutes to about 0.95 grams per 10 minutes. In some aspects, the melt index of the blend is measured according to ASTM D1238.

In some aspects, the compatibilized polymer blend includes a chemically modified olefinic thermoplastic elastomer. The chemical modification can increase the miscibility of the blend as compared to the same olefinic TPE without the chemical modification. Suitable chemical modifications can include functionalization with polar functional groups covalently bonded to polymer chains of the chemically modified thermoplastic elastomer. Such polar functional groups include, but are certainly not limited to, maleic anhydride. In various aspects, the polar functional groups are bonded to a backbone region, an end group, a side chain, or combination thereof, of the polymer chains. In some aspects, the olefinic thermoplastic elastomer in the resin consists essentially of a chemically modified polyether-polyester thermoplastic elastomer.

In some aspects, the compatibilized blend is compatibilized at least in part by using a comaptibilizing agent added to the blend. In some aspects, the compatibilizing agent is a surfactant. In some aspect, the surfactant is a polymer surfactant. In some aspects, the polymer surfactant is a block copolymer comprising a first block that is miscible and/or compatible with the olefinic TPE and a second block that is miscible and/or compatible with the EVA. In various aspects, the surfactant reduces the interfacial tension between the immiscible phases.

The compatibilized polymer blend can include the EVA and the olefinic TPE in various proportions. In some aspects, the compatibilized polymer blend includes about 10% by weight to about 20% by weight, about 20% by weight to about 30% by weight, about 30% by weight to about 40% by weight, about 40% by weight to about 50% by weight, about 50% by weight to about 60% by weight, about 60% by weight to about 70% by weight, about 70% by weight to about 80% by weight, or about 80% by weight to about 90% by weight of the first ethylene vinyl acetate copolymer based upon a total weight of the polymer blend. In some aspects, the compatibilized polymer blend includes about 10% by weight to about 20% by weight, about 20% by weight to about 30% by weight, about 30% by weight to about 40% by weight, about 40% by weight to about 50% by weight, about 50% by weight to about 60% by weight, about 60% by weight to about 70% by weight, about 70% by weight to about 80% by weight, or about 80% by weight to about 90% by weight of the olefinic thermoplastic elastomer based upon a total weight of the polymer blend.

In various aspects, this disclosure provides resin compositions including about 65 parts per hundred resin to about 100 parts per hundred resin of a polymer blend described herein; from 0 to about 20 parts per hundred resin of a second ethylene vinyl acetate copolymer; about 0.1 parts per hundred resin to about 5 parts per hundred resin of zinc oxide; about 1 parts per hundred resin to about 10 parts per hundred resin of calcium carbonate; about 1 parts per hundred resin to about 10 parts per hundred resin of a chemical blowing agent; and about 0.1 parts per hundred resin to about 1.5 parts per hundred resin of a crosslinking agent. The polymer blend is a compatibilized polymer blend described herein.

In some aspects, the resin composition includes about 65 parts per hundred resin to about 100 parts per hundred resin, about 70 parts per hundred resin to about 95 parts per hundred resin, about 75 parts per hundred resin to about 90 parts per hundred resin, about 80 parts per hundred resin to about 90 parts per hundred resin, about 80 parts per hundred resin to about 95 parts per hundred resin, about 85 parts per hundred resin to about 95 parts per hundred resin, or about 85 parts per hundred resin to about 90 parts per hundred resin of the compatibilized polymer blend based upon the total weight of the resin composition.

The compatibilzed polymer blend can further be mixed or blended with a second ethylene vinyl acetate copolymer in the resin composition. In some aspects, the resin compositions include from 0 to about 20 parts per hundred resin, or from 5 to about 15 parts per hundred resin of the second ethylene vinyl acetate copolymer. In some aspects, the second ethylene vinyl acetate copolymer has a melt index of about 1 gram per 10 minutes to about 3 grams per 10 minutes. In some aspects, the second ethylene vinyl acetate copolymer has a vinyl acetate content of about 15% to about 35% by weight based upon a weight of the second ethylene vinyl acetate copolymer.

In some aspects, the chemical blowing agent is a carbonate, bicarbonate, carboxylic acid, azo compound, isocyanate, persulfate, peroxide, or a combination thereof. The resin composition can include about 1 parts per hundred resin to about 10 parts per hundred resin, or about 3 parts per hundred resin to about 7 parts per hundred resin of the chemical blowing agent. In some aspects, the chemical blowing agent has a decomposition temperature of about 130° C. to about 160° C., or about 135° C. to about 155° C.

In some aspects, the crosslinking agent is an aliphatic unsaturated amides, such as methylenebisacryl- or -methacrylamide or ethylenebisacrylamide; aliphatic esters of polyols or alkoxylated polyols with ethylenically unsaturated acids, such as di(meth)acrylates or tri(meth)acrylates of butanediol or ethylene glycol, polyglycols or trimethylolpropane; di- and tri-acrylate esters of trimethylolpropane; acrylate and methacrylate esters of glycerol and pentaerythritol; allyl compounds, such as allyl (meth)acrylate, alkoxylated allyl (meth)acrylate, triallyl cyanurate, triallyl isocyanurate, maleic acid diallyl ester, poly-allyl esters, vinyl trimethoxysilane, vinyl triethoxysilane, polysiloxane comprising at least two vinyl groups, tetraallyloxyethane, tetraallyloxyethane, triallylamine, and tetraallylethylenediamine; or a mixture thereof. In some aspects, the resin composition includes about 0.1 parts per hundred resin to about 1.5 parts per hundred resin, or about 0.3 parts per hundred resin to about 0.8 parts per hundred resin of the crosslinking agent.

In some aspects, the zinc oxide is present from about 0.1 parts per hundred resin to about 5 parts per hundred resin, or about 0.7 parts per hundred resin to about 2 parts per hundred resin. In some aspects, the calcium carbonate is present from about 1 parts per hundred resin to about 10 parts per hundred resin, or from about 3 parts per hundred resin to about 7 parts per hundred resin. The resin compositions, in some aspects, include a dye or pigment. In some aspects, the dye or pigment is present in the resin composition at a level of about 0 parts per hundred resin to about 10 parts per hundred resin, or about 0.5 parts per hundred resin to about 5 parts per hundred resin based upon the weight of the resin composition.

Methods of Making Resin Compositions

In various aspects, this disclosure also provides a method for making a resin composition, the method including blending a compatibilzed blend described herein with an ethylene vinyl acetate copolymer, and further adding of zinc oxide, calcium carbonate, a chemical blowing agent, and a crosslinking agent. Additional additives such as dyes and pigments can also be added.

In some aspects, the methods include receiving an already compatibilized blend for forming the resin composition. While, in some aspects, the methods include forming the compatibilized polymer blend. For example, the compatibilzed polymer blend can be formed by chemically treating the olefinic thermoplastic elastomer. The methods of making the compatibilzed blend can further include extruding the blended polymers. In some aspects, additional steps include modification by adding a compatibilzing agent to the blend.

Chemical treatment can include a chemical modification of the olefinic thermoplastic elastomer. The chemical modification can increase the miscibility of the blend as comparted to use of the same olefinic TPE without the chemical modification. The methods can include attaching one or more polar functional groups, such as maleic anhydride, to the olefinic TPE. Attachment can occur at a backbone region, an end group, a side chain, or a combination thereof.

Suitable comaptibilzing agents can include surfactants. In some aspect, the surfactant is a polymer surfactant. In some aspects, the polymer surfactant is a block copolymer comprising a first block that is miscible and/or compatible with the olefinic TPE and a second block that is miscible and/or compatible with the EVA. In various aspects, the surfactant reduces the interfacial tension between the immiscible phases.

The resin compositions provided herein can be made by blending the components as described above. Methods of blending polymers can include film blending in a press, blending in a mixer (e.g. mixers commercially available under the tradename “HAAKE” from Thermo Fisher Scientific, Waltham, Mass.), solution blending, hot melt blending, and extruder blending. In some aspects, the polymeric resin modifier and polyolefin copolymer are miscible such that they can be readily mixed by the screw in the injection barrel during injection molding, e.g. without the need for a separate blending step.

The methods can further include extruding the blended resin composition to form an extruded resin composition. The methods of extruding the blended resin can include manufacturing long products of relatively constant cross-section (rods, sheets, pipes, films, wire insulation coating). The methods of extruding the blended resin can include conveying a softened blended resin composition through a die with an opening. The blended resin can be conveyed forward by a feeding screw and forced through the die. Heating elements, placed over the barrel, can soften and melt the blended resin. The temperature of the material can be controlled by thermocouples. The product going out of the die can be cooled by blown air or in a water bath to form the extruded resin composition. Alternatively, the product going out of the die can be pelletized with little cooling as described below.

The method can further include pelletizing the extruded resin composition to form a pelletized resin composition. Methods of pelletizing can include melt pelletizing (hot cut) whereby the melt coming from a die is almost immediately cut into pellets that are conveyed and cooled by liquid or gas. Methods of pelletizing can include strand pelletizing (cold cut) whereby the melt coming from the die head is converted into strands (the extruded resin composition) that are cut into pellets after cooling and solidification.

Methods of Making Components and Articles

The disclosure provides several methods for making components and articles described herein. In various aspects, the methods include foaming and crosslinking a resin composition described herein, molding the foam composition using a mold to form a molded foam composition; solidifying the molded foam composition in the mold to form the foam component; and removing the foam component from the mold.

The manufacturing methods of described herein allow for production of high quality component for articles of footwear, apparel, and sporting goods having a combined design of colors and physical properties in a simple and low cost manner. The methods can include injection molding, calender molding, and/or compression molding a resin composition described herein. The methods can include a compression remolding step. The disclosure provides methods for manufacturing a component for an article of footwear or sporting equipment, by foaming a resin composition described herein.

The methods can further include providing a component containing a resin composition, and providing a second element, and affixing the component to the second element. The second element can include a textile or multilayer film. For example, the second element can include an upper.

Calender Molding Process

The methods can include forming a film of the material using a calender molding process from a resin composition described herein. The film can then be foamed directly to make a foamed sheet, or the film can be molded before being foamed. The calender molding process is for forming a film type material. The resin composition is passed through the roll mixing mill to produce thin films having a wide variety of thicknesses. Preferably, the temperature is maintained at a low level ranging from 30° C. to 80° C. during the calender molding process so as to suppress production of foam during the processing of the resin composition containing the chemical foaming agent dispersed within the material. The temperature level can vary in accordance with the decomposition start temperature of the foaming agent and the temperature condition for foam molding a foam. If the temperature is higher than the above-defined temperature level, foam production may occur during the early stage of the film manufacturing process. If the temperature is lower than the above-defined temperature level, the film may be hardened during the early stage of the process, which may cause cracks of the film after being wound or in the post process. The material passed through the calender molding roll is formed into a film-shaped material through the subsequent processes including a cold rolling, trimming, winding and cutting processes.

Films with different hardness and/or colors can be manufactured by making the composition ratio between the main component and sub component different. A colorant may be added. Processes of the present invention can be performed prior to the material loading into a cavity of molding mold or prior to the closing of the molding mold for heat and pressure application, which differs from the conventional processes and techniques where only the processes for the material to be injected or loaded into the molding mold are performed, and subsequent processes including a material injection, closing of molding die and application of heat and pressure to the molding die are formed.

In some aspects, films with different properties and colors are prepared so as to allow each part within a component to have different properties, and achieve diversification of design of the component. The films can be stacked and/or combined into the cavity of the molding mold, and the molding mold is applied with heat and pressure so as to produce foam. This process is simple and economic.

In other aspects, the films are foamed following the calendaring process, producing foamed sheet stock. The foamed sheet stock is then cut to shape for use as is, or is cut to form a shape which is then remolded in a compression remolding process.

Injection Molding Process

In some aspects, the methods of forming a foam component include an injection molding process. An injection molding process mainly uses a pellet type resin composition as described herein. In some aspects, the amount of pelletized resin composition used can be measured and weighed in consideration of the volume of the mold cavity and expansion ratio of the palletized resin composition.

In some aspects, the pelletized resin material is molten in an injecting machine and injected into the cavity of the injection molding mold along the channel of the molding mold. The molding mold is pressed and, optionally, heated, for a predetermined time period following the injection. The molding mold is then released and rapidly opened. The form is cooled for a predetermined time period in the space with no pressure to produce a foamed component. Depending upon the type of blowing agent used and the injection conditions used, the molten resin may foam as it is injected into the molding mold, or the resin may foam prior to releasing and opening the molding mold, or the resin may foam after the molding mold is released and opened.

In aspects where the foaming occurs following the opening of the molding mold, the molding mold may be miniaturized in accordance with the volume and shape of the final form. For example, the molding mold may have a size of 130 to 200% of the final foamed component, and is designed and produced in such a manner that the form can be freely released from the molding mold when foamed.

Compression Molding

In some aspects, the methods of forming a foam component include a compression molding process. The compression molding process can be used to foam resin films or pellets, or can be used to shape foam sheets or foam pellets.

In one example of compression molding, a plurality of films or resin pellets can be prepared prior to a compression molding process. The films or pellets can have the same or different properties and/or colors and patterns. If films are used, the films are cut to fit the cavity of a molding mold. If pellets are used, the resin pellets are sized such that a large plurality of the pellets fit within the molding mold. In some aspects, the molding mold is miniaturized in accordance with the volume and shape of the final foam component.

The cut films or pellets can be stacked and/or combined into the molding mold. In some examples, the molding mold has a size of 130 to 200% of the final form, and is designed and produced in such a manner that the form can be freely released from the molding mold when foamed.

The molding mold is applied with a predetermined temperature and pressure such as, wherein the temperature ranges 130° C. to 170° C. in a compression molding process, and the temperature and heating time may change in accordance with the composition ratio of material, size and shape of the molding mold, purpose of the molded article and conditions of machine in the production line. The molding die is released from the pressure and open. The chemical foaming agent is decomposed in the heating process, and high temperature gases including N₂ and CO₂ contained in the resin composition expand, to thereby produce foam in the molded form. Subsequently, the molded form is trimmed, washed off, cooled and contracted, such that the molded form has stable size, volume and properties.

In another example of compression molding, a plurality of foam sheets or foam pellets can be prepared prior to a compression molding process. The foam sheet or foam pellets can have the same or different properties and/or colors and patterns. If foam sheets are used, the sheets are cut to fit the cavity of a molding mold. If foam pellets are used, the foam pellets are sized such that a large plurality of the pellets fit within the molding mold. In some aspects, when the density of the final foam component is going to be greater than the density of the foam sheets or foam pellets used, the molding mold is miniaturized in accordance with the volume and shape of the final foam component.

The cut sheets or pellets can be stacked and/or combined into the molding mold. In some examples, the molding mold has a size of 130 to 200% of the final form, and is designed and produced in such a manner that the form can be freely released from the molding mold.

The molding mold is applied with a predetermined temperature and pressure, such as, wherein the temperature ranges 130° C. to 170° C. in a compression molding process, and the temperature and heating time may change in accordance with the composition ratio of material, size and shape of the molding mold, purpose of the molded article and conditions of machine in the production line. The molding die is released from the pressure and open, exposing a unitary molded foam form. Subsequently, the molded form is trimmed, washed off, cooled and contracted, such that the molded form has stable size, volume and properties.

Compression Remolding

The methods, in some aspects, also include compression remolding of a foam component to produce a remolded foam component. For compression remolding, an intermediate foam form is loaded into the cavity of a compression mold. Optionally, the intermediate foam form is heated before being loaded into the cavity or is heated after being loaded into the cavity. The mold cavity is closed using compressive force, and the intermediate foam form is shaped by the mold surface of the mold cavity of the compression mold. The pressure is released and the remolded form is released from the compression mold so as to be used as a final form. In some aspects, the compression remolding includes compression remolding at a compression ratio of about 140% to about 200% to form the remolded foam component. The compression remolding can include annealing the foam component prior to compression remolding the foam component, or can include annealing the remolded foam component, or can include both.

Property Analysis and Characterization Procedure

Split Tear Test

The split tear test method used to obtain the split tear values for foam articles is as follows.

Four die-cut, rectangular-shaped samples of slab sheet or molded foam were prepared, each measuring 2.54 cm×15.24 cm×10±1 mm (thickness). If the foam material to be tested had a skin, the material had its skin removed before preparing the four samples. A 3 cm long cut was made in the center from one end of the sample. Then five successive 2 cm portions were marked on the sample.

The crosshead speed of the tensile test apparatus was set at 50 mm/min. Each separated end of the sample was clamped in an upper grip and a lower grip of the test apparatus. The separation was placed in the middle between both grips. Each section of the sample was held in a clamp in such a manner that the original adjacent cut edges formed a straight line joining the centers of the clamps.

As needed, the cut was aided with a sharp knife to keep separating the foam material in the center of the sample. Readings caused by cutting with the knife were discarded. The lowest values for each of the five portions of each sample were recorded in kg/cm. Five values were recorded for each sample and an average of the five values was then obtained and reported. If a portion of a sample included a portion having an air bubble more than 2 mm in diameter, the value for the portion including the air bubble was not included in the average. If more than one portion of a sample was found to include air bubbles having a diameter greater than 2 mm, another sample was then tested.

Durometer Hardness Test

The durometer hardness test used to obtain the hardness values for the foam articles is as follows.

For flat foams, the sample was a minimum of 6 mm thick for Asker C durometer testing. If necessary, foam samples were stacked to make up the minimum thickness. Foam samples were large enough to allow all measurements to be performed at a minimum of 12 mm from the edge of the sample and at least 12 mm from any other measurement. Regions tested were flat and parallel with an area at least 6 mm in diameter. Standard samples have dimensions of approximately 35 cm×13 cm×1.8 cm, and a minimum of five hardness measurements are typically taken and tested using a 1 kg head weight.

Compression Set Test

The compression set test used to obtain the compression set values for foam articles is as follows.

A foam sample was compressed between two metal plates to 50% of its original thickness and placed in an oven at 50° C. for 6 hours. The sample was then cooled and the difference between its precompression and post-compression thickness was used as the measure of static compression set.

For the tests, molded plaques having skin on one side and a thickness of 10 mm were used to obtain the samples. The plaque was then skived to a thickness of 10+/−0.5 mm to remove the skin before cutting the samples. Compression molded foam materials having skin on two sides had the skin skived from one side, so that skin remained on only one side. Five 2.54 cm diameter circles were then machine drilled from the plaque to obtain the samples to be tested.

The compression set testing device consists of two flat steel plates set between the parallel faces of the compression device with compression rings and spacer bars for each set of parallel faces. Four compression rings of the same thickness (4.5 mm or 5.0 mm based on the specimen thickness) were used for each parallel face of the compression device. The percent compression set was calculated using the following equation:

% Set=((Original gauge−final gauge)/(50% Original gauge))×100

The center area of each specimen was marked and used to measure the specimens with the use of an AMES gage with no load on top.

Enemy Return Test

The energy return test used to obtain the energy return values for foam articles is as follows. Energy return of the foam articles was determined using ASTM D 2632 92, which uses a vertical rebound apparatus.

### Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

All publications, patents, and patent applications cited in this specification are cited to disclose and describe the methods and/or materials in connection with which the publications are cited. All such publications, patents, and patent applications are herein incorporated by references as if each individual publication or patent were specifically and individually indicated to be incorporated by reference. Such incorporation by reference is expressly limited to the methods and/or materials described in the cited publications, patents, and patent applications and does not extend to any lexicographical definitions from the cited publications, patents, and patent applications. Any lexicographical definition in the publications, patents, and patent applications cited that is not also expressly repeated in the instant specification should not be treated as such and should not be read as defining any terms appearing in the accompanying claims.

Although any methods and materials similar or equivalent to those described herein can also be used in the practice or testing of the present disclosure, the preferred methods and materials are now described. Functions or constructions well-known in the art may not be described in detail for brevity and/or clarity. Aspects of the present disclosure will employ, unless otherwise indicated, techniques of nanotechnology, organic chemistry, material science and engineering and the like, which are within the skill of the art. Such techniques are explained fully in the literature.

It should be noted that ratios, concentrations, amounts, and other numerical data can be expressed herein in a range format. Where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.4%, 3.2%, and 4.4%) within the indicated range.

The term “providing,” as used herein and as recited in the claims, is not intended to require any particular delivery or receipt of the provided item. Rather, the term “providing” is merely used to recite items that will be referred to in subsequent elements of the claim(s), for purposes of clarity and ease of readability.

The terms “Split Tear Test”, “Durometer Hardness Test”, “Compression Set Test”, “Energy Return Test”, as used herein refer to the respective test methodologies described in the Property Analysis And Characterization Procedure section. These test methodologies characterize the properties of the recited materials, films, articles and components, and the like, and are not required to be performed as active steps in the claims.

The term “about,” as used herein, can include traditional rounding according to significant figures of the numerical value. In some aspects, the term about is used herein to mean a deviation of 10%, 5%, 2.5%, 1%, 0.5%, 0.1%, 0.01%, or less from the specified value.

The articles “a” and “an,” as used herein, mean one or more when applied to any feature in aspects of the present disclosure described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

The present disclosure will be better understood upon review of the following Aspects, which should not be confused with the claims.

Aspect 1. A resin composition comprising: about 65 parts per hundred resin to about 100 parts per hundred resin, about 70 parts per hundred resin to about 95 parts per hundred resin, about 75 parts per hundred resin to about 90 parts per hundred resin, about 80 parts per hundred resin to about 90 parts per hundred resin, about 80 parts per hundred resin to about 95 parts per hundred resin, about 85 parts per hundred resin to about 95 parts per hundred resin, or about 85 parts per hundred resin to about 90 parts per hundred resin of a polymer blend, the polymer blend comprising a first ethylene vinyl acetate copolymer and a olefinic thermoplastic elastomer, wherein the polymer blend is a compatibilized blend; from 0 to about 20 parts per hundred resin, or from 5 to about 15 parts per hundred resin of a second ethylene vinyl acetate copolymer; about 0.1 parts per hundred resin to about 5 parts per hundred resin, or about 0.7 parts per hundred resin to about 2 parts per hundred resin of zinc oxide; about 1 parts per hundred resin to about 10 parts per hundred resin, or from about 3 parts per hundred resin to about 7 parts per hundred resin of calcium carbonate; about 1 parts per hundred resin to about 10 parts per hundred resin, or about 3 parts per hundred resin to about 7 parts per hundred resin of a chemical blowing agent; and about 0.1 parts per hundred resin to about 1.5 parts per hundred resin, or about 0.3 parts per hundred resin to about 0.8 parts per hundred resin of a crosslinking agent.

Aspect 2. The resin composition according to any one of Aspects 1-24, wherein the olefinic thermoplastic elastomer is a chemically modified olefinic thermoplastic elastomer.

Aspect 3. The resin composition according to any one of Aspects 1-24, wherein the chemically modified olefinic thermoplastic elastomer includes polar functional groups covalently bonded to polymer chains of the chemically modified thermoplastic elastomer.

Aspect 4. The resin composition according to any one of Aspects 1-24, wherein the polar functional groups are bonded to a backbone region, an end group, a side chain, or combination thereof, of the polymer chains.

Aspect 5. The resin composition according to any one of Aspects 1-24, wherein the olefinic thermoplastic elastomer includes a polyether-polyester thermoplastic elastomer.

Aspect 6. The resin composition according to any one of Aspects 1-24, wherein the olefinic thermoplastic elastomer consists essentially of a chemically modified polyether-polyester thermoplastic elastomer.

Aspect 7. The resin composition according to any one of Aspects 1-24, wherein the compatibilized blend includes a compatibilizing agent.

Aspect 8. The resin composition according to any one of Aspects 1-24, wherein the compatibilizing agent is a surfactant.

Aspect 9. The resin composition according to any one of Aspects 1-24, wherein the compatibilized blend has a melt flow index of about 0.7 grams per 10 minutes to about 1.0 grams per 10 minutes.

Aspect 10. The resin composition according to any one of Aspects 1-24, wherein the polymer blend comprises about 10% by weight to about 20% by weight, about 20% by weight to about 30% by weight, about 30% by weight to about 40% by weight, about 40% by weight to about 50% by weight, about 50% by weight to about 60% by weight, about 60% by weight to about 70% by weight, about 70% by weight to about 80% by weight, or about 80% by weight to about 90% by weight of the first ethylene vinyl acetate copolymer based upon a total weight of the polymer blend.

Aspect 11. The resin composition according to any one of Aspects 1-24, wherein the chemical blowing agent is selected from the group consisting of a carbonate, bicarbonate, carboxylic acid, azo compound, isocyanate, persulfate, peroxide, and a combination thereof.

Aspect 12. The resin composition according to any one of Aspects 1-24, wherein the crosslinking agent is selected from the group consisting of aliphatic unsaturated amides, such as methylenebisacryl- or -methacrylamide or ethylenebisacrylamide; aliphatic esters of polyols or alkoxylated polyols with ethylenically unsaturated acids, such as di(meth)acrylates or tri(meth)acrylates of butanediol or ethylene glycol, polyglycols or trimethylolpropane; di- and tri-acrylate esters of trimethylolpropane; acrylate and methacrylate esters of glycerol and pentaerythritol; allyl compounds, such as allyl (meth)acrylate, alkoxylated allyl (meth)acrylate, triallyl cyanurate, triallyl isocyanurate, maleic acid diallyl ester, poly-allyl esters, vinyl trimethoxysilane, vinyl triethoxysilane, polysiloxane comprising at least two vinyl groups, tetraallyloxyethane, tetraallyloxyethane, triallylamine, and tetraallylethylenediamine; and mixtures thereof.

Aspect 13. The resin composition according to any one of Aspects 1-24, wherein the composition comprises about 85 parts per hundred resin to about 95 parts per hundred resin of the polymer blend.

Aspect 14. The resin composition according to any one of Aspects 1-24, wherein the composition comprises about 5 parts per hundred resin to about 15 parts per hundred resin of the second ethylene vinyl acetate copolymer.

Aspect 15. The resin composition according to any one of Aspects 1-24, wherein the composition comprises about 0.7 parts per hundred resin to about 2 parts per hundred resin of the zinc oxide.

Aspect 16. The resin composition according to any one of Aspects 1-24, wherein the composition comprises about 3 parts per hundred resin to about 7 parts per hundred resin of the calcium carbonate.

Aspect 17. The resin composition according to any one of Aspects 1-24, wherein the composition comprises about 3 parts per hundred resin to about 7 parts per hundred resin of the chemical blowing agent.

Aspect 18. The resin composition according to any one of Aspects 1-24, wherein the composition comprises about 0.3 parts per hundred resin to about 0.8 parts per hundred resin of the crosslinking agent.

Aspect 19. The resin composition according to any one of Aspects 1-24, wherein the melt index of the blend is measured according to ASTM D1238.

Aspect 20. The resin composition according to any one of Aspects 1-24, further comprising from 0 parts per hundred resin to about 10 parts per hundred resin of a dye or pigment.

Aspect 21. The resin composition according to any one of Aspects 1-24, wherein the composition comprises about 0.5 parts per hundred resin to about 5 parts per hundred resin of the dye or pigment.

Aspect 22. The resin composition according to any one of Aspects 1-24, wherein the second ethylene vinyl acetate copolymer has a melt index of about 1 gram per 10 minutes to about 3 grams per 10 minutes.

Aspect 23. The resin composition according to any one of Aspects 1-24, wherein the second ethylene vinyl acetate copolymer has a vinyl acetate content of about 15% to about 35% by weight based upon a weight of the second ethylene vinyl acetate copolymer.

Aspect 24. The resin composition according to any one of Aspects 1-23, wherein the chemical blowing agent has a decomposition temperature of about 130° C. to about 160° C.

Aspect 25. A composition comprising a crosslinked reaction product of a resin composition according to any one of Aspects 1-24.

Aspect 26. A foam composition made by a process comprising crosslinking and foaming a resin composition according to any one of Aspects 1-24.

Aspect 27. A foam component for an article of footwear comprising a foamed, crosslinked reaction product of a resin composition according to any one of Aspects 1-24.

Aspect 28. A method of making a foam component, the method comprising: foaming and crosslinking a resin composition comprising: about 65 parts per hundred resin to about 100 parts per hundred resin, about 70 parts per hundred resin to about 95 parts per hundred resin, about 75 parts per hundred resin to about 90 parts per hundred resin, about 80 parts per hundred resin to about 90 parts per hundred resin, about 80 parts per hundred resin to about 95 parts per hundred resin, about 85 parts per hundred resin to about 95 parts per hundred resin, or about 85 parts per hundred resin to about 90 parts per hundred resin of a polymer blend, the polymer blend comprising a first ethylene vinyl acetate copolymer and a olefinic thermoplastic elastomer, wherein the polymer blend is a compatibilized blend; from 0 to about 20 parts per hundred resin, or from 5 to about 15 parts per hundred resin of a second ethylene vinyl acetate copolymer; about 0.1 parts per hundred resin to about 5 parts per hundred resin, or about 0.7 parts per hundred resin to about 2 parts per hundred resin of zinc oxide; about 1 parts per hundred resin to about 10 parts per hundred resin, or from about 3 parts per hundred resin to about 7 parts per hundred resin of calcium carbonate; about 1 parts per hundred resin to about 10 parts per hundred resin, or about 3 parts per hundred resin to about 7 parts per hundred resin of a chemical blowing agent; and about 0.1 parts per hundred resin to about 1.5 parts per hundred resin, or about 0.3 parts per hundred resin to about 0.8 parts per hundred resin of a crosslinking agent to form a foam composition; molding the foam composition using a mold to form a molded foam composition; solidifying the molded foam composition in the mold to form the foam component; and removing the foam component from the mold.

Aspect 29. The method according to any one of Aspects 28-32, wherein the method further comprises compression remolding the foam component to form a remolded foam component.

Aspect 30. The method according to any one of Aspects 28-32, wherein the compression remolding includes compression remolding at a compression ratio of about 140% to about 200% to form the remolded foam component.

Aspect 31. The method according to any one of Aspects 28-32, wherein the compression remolding includes annealing the foam component prior to compression remolding the foam component, or includes annealing the remolded foam component, or includes both.

Aspect 32. The method according to any one of Aspects 28-31, wherein the foam component is a foam component of an article of footwear, apparel, or sporting equipment.

Aspect 33. A foam component, the foam component made by the method of any one of Aspects 28-32.

Aspect 34. The foam component according to any one of Aspects 33-38, wherein the foam component has an energy return of about 60% to 90%, about 60% to 85%, about 65% to 85%, or about 70% to 85%.

Aspect 35. The foam component according to any one of Aspects 33-38, wherein the foam component has a split tear of about 1.0 kg/cm to 4.5 kg/cm, about 1.6 kg/cm to 4.0 kg/cm, about 2.0 kg/cm to 4.0 kg/cm, about 2.0 kg/cm to 3.5 kg/cm, or about 2.5 kg/cm to 3.5 kg/cm.

Aspect 36. The foam component according to any one of Aspects 33-38, wherein the foam component has an Asker C hardness of about 30 to 65 C, about 40 to 65 C, or about 40 to 60 C.

Aspect 37. The foam component according to any one of Aspects 33-38, wherein the foam component has a compression set from 45% to 90%, from 40% to 80%, from 50% to 75%, or from 30% to 75%.

Aspect 38. The foam component according to any one of Aspects 33-37, wherein the foam component is a foam component of an article of footwear, apparel or sporting equipment

Aspect 39. An article of footwear comprising a foam component according to any one of Aspects 33-38.

Aspect 40. The article of footwear according to Aspect 39, wherein the component is a sole, and wherein the article of footwear further comprises an upper attached to the sole.

Aspect 41. A method of making an article of footwear, the method comprising affixing a component made according to the method of any one of Aspects 28-32 to a second footwear component, thereby forming the article of footwear.

Aspect 42. A method of making an article of footwear, the method comprising affixing a component according to Aspect 27 to a second footwear component, thereby forming the article of footwear.

Aspect 43. The method according to Aspect 41 or Aspect 42, wherein the component is a sole and the second footwear component is an upper.

We claim:

1. A foam component for an article of footwear, comprising:
a foamed, crosslinked reaction product of a resin composition comprising
about 65 parts per hundred resin to about 100 parts per hundred resin of a polymer blend, the polymer blend comprising a first ethylene vinyl acetate copolymer and an olefinic thermoplastic elastomer;
from 0 to about 20 parts per hundred resin of a second ethylene vinyl acetate copolymer;
about 0.1 parts per hundred resin to about 5 parts per hundred resin of zinc oxide;
about 1 parts per hundred resin to about 10 parts per hundred resin of calcium carbonate;
about 1 parts per hundred resin to about 10 parts per hundred resin of a chemical blowing agent; and
about 0.1 parts per hundred resin to about 1.5 parts per hundred resin of a crosslinking agent.

2. The foam component for an article of footwear according to claim 1, wherein the olefinic thermoplastic elastomer is a chemically modified olefinic thermoplastic elastomer.

3. The foam component for an article of footwear according to claim 2, wherein the chemically modified olefinic thermoplastic elastomer includes polar functional groups covalently bonded to polymer chains of the chemically modified thermoplastic elastomer.

4. The foam component for an article of footwear according to claim 3, wherein the polar functional groups are bonded to a backbone region, an end group, a side chain, or combination thereof, of the polymer chains.

5. The foam component for an article of footwear according to claim 1, wherein the olefinic thermoplastic elastomer includes a polyether-polyester thermoplastic elastomer.

6. The foam component for an article of footwear according to claim 1, wherein the olefinic thermoplastic elastomer consists essentially of a chemically modified polyether-polyester thermoplastic elastomer.

7. The foam component for an article of footwear according to claim 1, wherein the resin composition includes a compatibilizing agent.

8. The foam component for an article of footwear according to claim 7, wherein the compatibilizing agent is a surfactant.

9. The foam component for an article of footwear according to claim 1, wherein the resin composition has a melt flow index of about 0.7 grams per 10 minutes to about 1.0 grams per 10 minutes.

10. The foam component for an article of footwear according to claim 1, wherein the resin composition comprises about 85 parts per hundred resin to about 95 parts per hundred resin of the polymer blend.

11. The foam component for an article of footwear according to claim 1, wherein the resin composition comprises about 5 parts per hundred resin to about 15 parts per hundred resin of the second ethylene vinyl acetate copolymer.

12. The foam component for an article of footwear according to claim 1, wherein the second ethylene vinyl acetate copolymer has a melt index of about 1 gram per 10 minutes to about 3 grams per 10 minutes.

13. The foam component for an article of footwear according to claim 1, wherein the second ethylene vinyl acetate copolymer has a vinyl acetate content of about 15% to about 35% by weight based upon a weight of the second ethylene vinyl acetate copolymer.

14. The foam component for an article of footwear according to claim 1, wherein the foam component has an energy return of about 70% to about 85%.

15. The foam component for an article of footwear according to claim 1, wherein the foam component has a split tear of about 1.6 kg/cm to about 4.0 kg/cm.

16. The foam component for an article of footwear according to claim 1, wherein the foam component has an Asker C hardness of about 40 to 60 C.

17. The foam component for an article of footwear according to claim 1, wherein the foam component has a compression set of about 30% to about 75%.

18. A method of making a foam component for an article of footwear, the method comprising:
foaming and crosslinking a resin composition comprising about 65 parts per hundred resin to about 100 parts per hundred resin of a polymer blend, the polymer blend comprising a first ethylene vinyl acetate copolymer and a olefinic thermoplastic elastomer;
from 0 to about 20 parts per hundred resin of a second ethylene vinyl acetate copolymer;
about 0.1 parts per hundred resin to about 5 parts per hundred resin of zinc oxide;
about 1 parts per hundred resin to about 10 parts per hundred resin of calcium carbonate;
about 1 parts per hundred resin to about 10 parts per hundred resin of a chemical blowing agent; and
about 0.1 parts per hundred resin to about 1.5 parts per hundred resin of a crosslinking agent to form a foam composition;
molding the foam composition using a mold to form a molded foam composition;
solidifying the molded foam composition in the mold to form the foam component; and
removing the foam component for an article of footwear from the mold.

19. The method according to claim 18, wherein the method further comprises compression remolding the foam component for an article of footwear to form a remolded foam component for an article of footwear.

20. The method of claim 19, wherein the compression remolding includes annealing the foam component for an article of footwear prior to compression remolding the foam component for an article of footwear, or includes annealing the remolded foam component for an article of footwear, or includes both.
